(19) United States
(12) Patent Application Publication
(10) Pub. No.: US 2007/0198178 A1
(43) Pub. Date: Aug. 23, 2007

(54) Pathfinding system

(76) Inventors: Martin W. Trimby, Suffolk (GB); Marco FP Gillies, Greater London (GB); Daniel Ballin, Suffolk (GB)

Correspondence Address: NIXON & VANDERHYE, PC, 901 NORTH GLEBE ROAD, 11TH FLOOR, ARLINGTON, VA, 22203, US

(21) Appl. No.: 10/593,589

(22) PCT Filed: Mar. 16, 2005
(86) PCT No.: PCT/GB05/01009

§ 371 Date: Sep. 21, 2006

(30) Foreign Application Priority Data
Mar. 31, 2004 (GB) 0407385.4
Mar. 31, 2004 (GB) 0407390.4
Mar. 31, 2004 (GB) 0407311.0

(51) Int. Cl. G01C 21/30

(52) U.S. Cl. 701/209

(57) ABSTRACT

A computer system is arranged to automatically calculate a path along nodes in a virtual world. After the co-ordinates for the virtual world environment have been initially defined (40), including nodes along which a path may travel, the system automatically increases the density of nodes in the environment up to a desired density. New nodes are added between each pair of nodes which have line of sight to each other (44 to 47), dramatically increasing the number of available links and nodes. This is repeated until a sufficient density of nodes is reached and no more nodes are being added (48 and 49).

### TECHNICAL FIELD

The invention relates to a method and system for determining a path along a plurality of points in a virtual environment providing a representation of a real or virtual world.

### INTRODUCTION

Systems in which 3-dimensional virtual reality environments (virtual worlds) are defined and created are becoming increasingly prevalent in the current technological age. Such computer systems are applicable in numerous commercial applications, such as for online tourist sites, fantasy worlds, gaming, architectural walk-throughs, estate agency (virtual tours of houses for sale), and many others. Typically, a virtual world might be defined by multiple x,y,z, co-ordinate sets which together map out an environment in three dimensions (x, y, and z axes). The topology of the virtual world can be defined by way in which the objects within the virtual world are organised within the three dimensions, i.e., by the spatial location of a number of nodal points (also referred to herein as “nodes”). In this case, the topology is determined by the logical mesh which can be formed from nodes at specific co-ordinates in the world. The mesh may or may not be regularly spaced.

Objects and walls (or other items which exist within the virtual world), which a user navigating through the virtual world is not allowed to walk through, can be implemented by what is termed a collisionable mesh. The collisionable mesh may therefore comprise a further set of three dimensional co-ordinates defining shapes within the virtual world which the user must navigate around.

Navigation is required within virtual worlds for any entity passing through that world, such as a computer generated person, vehicle or gaming character. This is typically under the control of an external human user. Traditionally, many commercial implementations of virtual environments have been built on the basis of the self-navigation techniques inherited from games engines, where exploration of all areas of an unknown virtual world is expected, and also a high degree of user competency is assumed. However, as the application of virtual worlds spreads into other commercial areas, it is important that the functionality of navigation evolves to suit the competency and requirements of a whole new wider group of users. Such users may not be as proficient in the navigation around virtual worlds, and furthermore may be disinclined to spend large amounts of time familiarising themselves with the environment. They are likely to become disorientated or bored much more quickly, or even miss important content entirely, unless the user experience is significantly improved.

In our day-to-day lives, humans typically employ various techniques to help us with our navigation when moving from place to place. We retain an idea of our location, and orientation using fixed points of reference (landmarks), measures of distance travelled and changes in direction so as to prevent ourselves becoming disorientated. Such techniques may not be available to the novel user in a virtual world which they are unfamiliar, particularly if teleporting (e.g. instantaneously transferring between two different points in the world) is applied, as is the case in many gaming environments. Consequently, it is advantageous to provide an automated pathfinding system for the inexperienced user to help them navigate them through the virtual world, allowing them to overcome the problems of lack of familiarity and any frustrations with the traditional interface of self-navigation. Consequently, many systems have been developed which automatically calculate the best path through a virtual world, for example to find the shortest path to view a particular object or to pass through a room.

As more and more systems are becoming available for determining an optimal path between a set of points it is becoming more and more important for the paths which are generated to be user friendly as well as optimal in terms of efficiency. System may provide representations of both virtual environments (for example, where such systems can be implemented as games or other virtual world environments) or representations of real environments (for example, where such systems can comprise navigational aids for both sea and land environments),

However, even when pathfinding is automated and a guided path is provided for a user to automatically navigate along, a user may become confused when many changes of direction occur. These may be actual changes in direction of the guided path, or changes in direction of the field of view of the user as they are navigating along the guided path.

The result in both cases is for the user to become more disorientated, and to lose their sense of direction. Accordingly, it is useful if the guided path along which a user is automatically navigated can be constrained so that the if, when navigating along a path automatically generated from A to B, the path changes direction several times. As the user becomes more familiar, they may wish to follow a more winding path, as they will still maintain their sense of orientation. Accordingly, it is useful if the angle differential between the mesh points used to generate the path can be constrained according to a user's personal preference.

### PRIOR ART

Nodal path generation is well known, for example, see “Smart Moves: Intelligent Pathfinding” by Bryan Stout, published in Game Developer, October 1996, and also available online at http://www.gamasupra.com/features/19970801/pathfinding.htm provides an broad introduction to various pathfinding techniques which can be used in virtual worlds. In particular, it discusses and compares breadth-first pathfinding (including Dijkstra's Algorithm), depth-first and best-first pathfinding techniques.

All pathfinding algorithms work by expanding possible paths, one node at a time until a path from the start node to the destination node is found. The order in which the nodes are attempted is critical to the speed and quality (e.g. length) of the final path that is found. In a breadth-first techniques, the algorithm searches firstly through all a nodes' immediate neighbours, and then moving onto the neighbours of those neighbouring nodes. In contrast, in depth-first techniques, the algorithm searches for a path recursively using a child node each time until reaching a predetermined depth, at which point it retraces it's steps and tries other child nodes. A best-first search chooses paths preferentially on the basis of an estimate of the shortest remaining distance to the goal. However, Stout does not discuss the problems associated with constraining the angle differential between nodes.

The document discusses the various merits and disadvantages of search algorithms, including the preferred search algorithm known as A*, which provides an optimal method (both in terms of processing requirements and quality of path) for many types of pathfinding problems. The document proposes different techniques for overcoming some of the disadvantages in the A* algorithm. These include how to select an estimate of the remaining distance to the goal, and how the processing requirements can be reduced by splitting the virtual world into different regions (which can then be calculated separately) and using more efficient data structures.

The article entitled “Middleware Solutions for Artificial Intelligence in Computer Games” (Chapter 3—Al Techniques) by Jan-Harald Fredriksen of the Norwegian University of Science and Technology, located at http://www.idi.ntnu.no/grupper/su/fordypningsprosiekt-2003/fordypning2003-Jan-Harald-Fredriksen.pdf is also concerned with pathfinding techniques in virtual worlds, and the use of the A* algorithm. This document considers the use of cost constraints for different terrains to be taken into account when calculating a path through the virtual world, and the use of hierarchical pathfinding (finding a broad overall route before computing the detailed portions) and portals (which split regions of the virtual world into smaller parts) for improved computation performance. However, Fredriksen does not consider applying constraints to the path generation such as angle-differential.

Fredriksen describes two alternative versions for the underlying structure of the virtual world on which the pathfinding in this document is based has two alternative versions. The first is referred to as the POV (points of visibility) approach, in which a plurality of nodes (called waypoints) are introduced into the virtual world, and which the path is found on the basis of line-of-sight links between the nodes. The second approach is the use of a navigation mesh in which a plurality of convex polygons cover the surface of the world, and in this case the pathfinding algorithm considers each polygon to be a node and calculates a path through the virtual world accordingly.

In addition, there currently exist systems for automating the plotting of travel routes through parts of the real world. A good example of such a system is the “Route Planner” tool provided on the web-site of The M organisation (see http://www.theAA.com). Such systems take into account certain preferences of the user (e.g. to avoid motorways, shortest distance, shortest time, etc). However the present inventors are not aware of any systems which enable routes to take account of less utilitarian preferences of users in anything less than a very rudimentary manner. Also, such systems are necessarily restricted to calculating a route along predefined paths (i.e. where roads exist), and are therefore restricted in the flexibility of the final route that is generated.

### SUMMARY OF THE INVENTION

According to a first aspect of the present invention, there is provided a method of determining a path along some of a plurality of points in a representation of a virtual world, the representation comprising a plurality of initially defined points, and obstructions through which the path cannot pass, the method comprising:
(a) defining a plurality of additional points by repeating the following step: defining a new point located on a line between two existing points, wherein the line does not pass through any of the obstructions; and
(b) calculating the path based on any combination of new and/or initially defined points

The constraint may be imposed by assigning a varying angle of deviation cost value in dependence on the angle to which the first line deviates from the second line.

The angle of deviation cost value may be zero when said angle is 180 degrees, and said angle of deviation cost value is a maximum when said angle is 360 degrees.

Alternatively, an alternative system of reference may be used to define the angle of deviation, in which case the cost value may be higher when the angle is 180 degrees, and lower when it is zero degrees.

The environment may comprise a virtual world.

The representation may model a real world navigable environment. The navigable environment may comprise a sea-based environment and/or a land-based environment.

The angle of deviation may be constrained to a predetermined range. The range of the angle of deviation may be determined as a function of a range of angles within which the first line approaches the new point from the first point, and a predetermine angle of deviation.

The method may be performed to create the content of the virtual environment and/or the method may be performed after the content creation of the virtual environment to dynamically determine the path.

Advantageously, if the nodal subdivision process of the invention is performed at least partially prior to generating a spline path from a start node to a destination node, the processing required to generate the spline path is reduced. For example, if a node is static within the virtual environment, sub-divisions of the nodal space around that node may be advantageously performed as a preprocessing stage prior to generating a path. However, if the virtual environment is populated with may nodes which are dynamically changing such a preprocessing stage may provide a smaller performance gain.

The path determined may have a dynamically changing destination node. The path determined may define a field of view of said virtual environment.

A second aspect of the invention seeks to provide a system for determining a path along some of a plurality of points in a representation of an environment, the representation comprising a plurality of initially defined points, and obstructions through which the path cannot pass, the system comprising: processing means to define a plurality of additional points by repeatedly defining a new point located between a first existing point and a second existing point, wherein a first line between the first point and the new point and a second line between the new point and the second point do not pass through any of the obstructions; and processing means to calculate the path based on any combination of new and/or initially defined points, wherein the angle of deviation of the first line to a line between the first and second points is constrained.

The system may further comprise means to enable a user to be automatically navigated along said path.

The system may comprise means to enable a user to select the degree to which the rate of curvature of the path changes as a function of distance along the path, i.e. the degree to which the path wiggles.

A third aspect of the invention provides a user interface for a system according to the second aspect, wherein the user interface is arranged to provide said means to enable the user to select said degree to which said path is wiggly (i.e., the degree to which the rate of curvature of the path changes as a function of distance along the path).

The user interface may be provided to implement content creation of the virtual world and/or implement a user profile for said virtual environment.

A fourth aspect of the invention provides a storage medium carrying computer readable code representing instructions for causing one or more processors to perform the method of the first aspect when the instructions are executed by the processor or processors.

A fifth aspect of the invention provides a computer program comprising instructions for causing one or more processors to perform the method according to the method of the first aspect when the instructions are executed by the processor or processors.

A sixth aspect of the invention provides a computer data signal embodied in a carrier wave and representing instructions for causing one or more processors to perform the method according to any of the first aspects when the instructions are executed by the processor or processors.

A seventh aspect of the invention provides a storage medium carrying computer readable code representing instructions for causing one or more processors to operate as the system according to the second aspect when the instructions are executed by the processor or processors.

An eighth aspect of the invention provides a computer program comprising instructions for causing one or more processors to operate as the system according to the second aspect of the invention when the instructions are executed by the processor or processors.

A ninth aspect of the invention provides a computer data signal embodied in a carrier wave and representing instructions for causing one or more processors to operate as the system according to the second aspect of the invention when the instructions are executed by the processor or processors.

According to another aspect of the present invention, there is provided a system for storing a representation of a virtual world, the representation comprising a plurality of initially defined points, and obstructions through which the path cannot pass, and in which two points are said to have line of sight if a straight line link between the two points does not pass through any of the obstructions, the system being arranged to determine a path along some of a plurality of points in said representation by
(a) defining a plurality of additional points by repeating the following step: defining a new point located on a line of sight link between two existing points
(b) calculating the path based on any combination of new and/or initially defined points.

According to another aspect of the present invention, there is provided a method of generating a route through an environment comprising: associating a region of influence with one or more locations within the environment; associating one or more weightings with a user, at least one of which weightings indicates the level of interest which the user has in viewing one or more of said locations within the environment having a region of influence associated therewith; and calculating a path through the environment; wherein the step of calculating a path through the environment depends upon whether the calculated path passes through one or more regions of influence and any weighting indicating the level of interest in the location or locations associated with any such region or regions of influence.

In a preferred embodiment, the region of influence is a sphere of influence which is formed by determining a radius of influence. The radius of influence is preferably chosen such that at least one significant feature of the location is still able to influence to at least some extent some aspect of the environment as observed or experienced by a user or other observing entity in a position removed from the location by up to the radius of influence in at least one direction. Alternatively, the radius of influence may be chosen such that at least one significant feature of the location is still able to influence to at least some extent some aspect of the environment as observed or experienced by a user or other observing entity in a position removed from the location by up to the radius of influence in any permissible direction. Alternatively, the region of influence could be an interrupted sphere in which certain portions of the sphere are excluded (possibly because of a collisionable mesh obstructing the natural view of an entity when located within the excluded region.

Preferably, the region of influence is taken into account when generating a path by using a path generating algorithm which searches for an optimal path through multiple possible paths in which a final path is built up by iteratively expanding a partial path, in which the partial path has an associated cost at each stage, which cost depends on the extent to which the partial path passes through one or more regions of influence. The cost is preferably calculated by assigning a component of the cost to each node forming part of the partial path and wherein the size of the component depends on whether the node is within or without a region of influence. Preferably, the amount of “influence” associated with a particular region of influence varies in inverse dependence on the Euclidean distance from the associated location between a maximum amount of influence at the location and zero influence at the edge of the region of influence.

According to another aspect of the present invention, there is provided a method of controlling the field of view of a virtual entity travelling through a virtual world, the method comprising associating with one or more other virtual entities a region of influence and generating a field of view parameter in respect of the virtual entity which controls the field of view associated with the entity as it travels through the virtual world wherein the field of view parameter is calculated in a manner which depends upon whether the virtual entity is within or without a region of influence.

Preferably, as the travelling entity passes into and through a region of influence its field of view parameter is calculated to be such as to cause the field of view to encompass the other entity associated with the region of influence, unless it is outweighed by the influence of a different region of influence of another entity. Preferably the amount of influence associated with an entity varies in inverse dependence on the Euclidean distance from the associated location between a maximum amount of influence at the location and zero influence at the edge of the region of influence.

Another aspect of the invention relates to a method of generating an automated path along some of a plurality of points in a virtual environment in which the rate of curvature of the path as a function of distance along the path is constrained, the method comprising determining the path in a topology comprising a plurality of initially defined points, and obstructions through which the path cannot pass, and in which two points are said to have line of sight in said topology if a straight line link between the two points does not pass through any of the obstructions, the method comprising: (a) selecting a start point and an end point for said path in said virtual environment; (b) dynamically redefining the topology of the virtual environment in the vicinity of said start point and said end point and the region between said start point and said end point by generating a plurality of additional points, wherein said plurality of additional points are generated by repeating the following step: defining a new point located between a first existing point and a second existing point, wherein a first line between the first point and the new point and a second line between the new point and the second point do not pass through any of the obstructions; and (c) calculating the path based on any combination of new and/or initially defined points, wherein the angle of deviation of the first line to a line between the first and second points is constrained.

The speed of navigation along the path may be determined as a function of the rate at which the degree of curvature of the path changes as a function of distance along the path.

This invention is applicable to any type of virtual world, which might include for example fantasy worlds or worlds based upon a real environment such as a historic building or design for a future building, or a house that is for sale, and in which the obstructions might comprise walls or other obstacles, for example. The representation in the sense used above is likely to refer to stored digital data that represents such a world. Alternatively, the virtual environment may provide a representation of the real world.

The new point may be located on the mid point of the link. Step (a) may further comprise deleting the new point if it is less than a predefined distance from another of the points, and the predefined distance may vary in different regions of the virtual world. The method may further comprise identifying a link as not being suitable for providing the location for a new point if said link intersects another one of said links which is shorter. A new point may be deleted if it does not have line of sight to each of a pair of points which do not have line of sight to each other and/or may be deleted if it does not form part of a path between two other nodes that is shorter than the shortest path which would exist between said two points without said new point.

Advantageously, the arrangements of the invention employ a technique which allows a content provider to define some initial points for navigation in a virtual world, allowing the content provider to influence the routes taken and the items of interest that can be visited by a user. The system then automatedly multiplies the number of points in a manner which will improve the user's experience along the subsequently generated path through the environment compared with only a limited set of originally defined navigation points.

In comparison with previously known systems in which a path through a virtual world is not constrained to specific navigation points, the embodiments of the invention provide improved processing during the actual pathfinding procedure. This is because no collision detection (ensuring the path avoids obstacles, etc) is required during pathfinding in the embodiments since all the new navigable nodes and links have been added on line of sight principles, and therefore by definition already avoid all the potential obstacles.

Additionally, these embodiments provide advantages over previous known systems such as the AA Routefinder which are necessarily limited to finding routes along specified predefined roads, etc. In contrast, in the embodiments, the user is able to navigate within all areas of the virtual world.

The present invention also relates to corresponding systems and computer programs for performing the method aspects of the invention.

Aspects of the invention are also set out in the accompanying claims, together with dependent claims representing preferred features of the invention. The preferred features of the invention may be suitably adapted to be combined with each other and/or with any of the aspects of the invention as is apparent to those skilled in the art.

### BRIEF DESCRIPTION OF THE DRAWINGS

For a better understanding of the present invention, specific embodiments will now be described, by way of example, with reference to the accompanying drawings, in which:

FIG. 1 shows a schematic of a system according to an embodiment of the invention;

FIG. 2 shows a diagrammatic representation of a virtual world environment;

FIGS. 3 to 12 show further diagrammatic representations of the virtual world environment of FIG. 2; and

FIG. 13 shows a flow chart of the method for processing points within a virtual world according to one embodiment of the invention;

FIGS. 14A to 14C show how an angle differential weighting influences the connection angle between two nodes in a virtual world according to one embodiment of the invention;

FIGS. 15A and 15B show two wiggly paths with differing degrees of waviness.

FIG. 16A shows a navigational node with a valid LoS Angle range constraint;

FIG. 16B shows how range of LoS angles may implement a constraint on the connection angel between two nodes according to another embodiment of the invention; and

FIG. 17 shows how a range of LoS angles may implement a constraint on the angle of entry and angle of exit of an automatedly generated path passing through a node according to another embodiment of the invention.

### DETAILED DESCRIPTION OF EMBODIMENTS OF THE INVENTION

There follows a detailed description of the preferred embodiments of the invention, which include a description of the best mode of the invention as currently contemplated by the inventors. Even where not explicitly described, it will be apparent to those skilled in the art that certain features of the invention can be replaced by their known equivalents, and the scope of the invention is intended to include such apparent equivalents to the described features where appropriate.

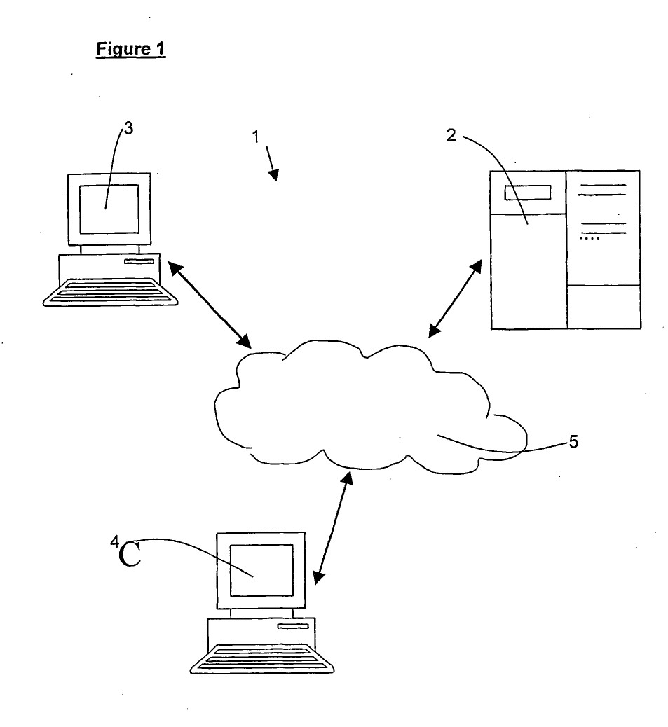

FIG. 1 illustrates a system 1 for creating, and allowing a user to navigate within, a virtual world. The system comprises a, server computer 2, accessible to a content provider (a human user who will input the specification for the virtual world) via terminal 3, and accessible to a user (desiring to view and navigate through the virtual world) via another terminal 4. In this particular embodiment, access from both terminals to the server 2 is through a general network 5, such as for example the internet, although it is understood that the illustrated computer arrangement may be replaced by any suitable alternative which allows a content provider to design and implement a virtual world, which a user can subsequently access and interact with.

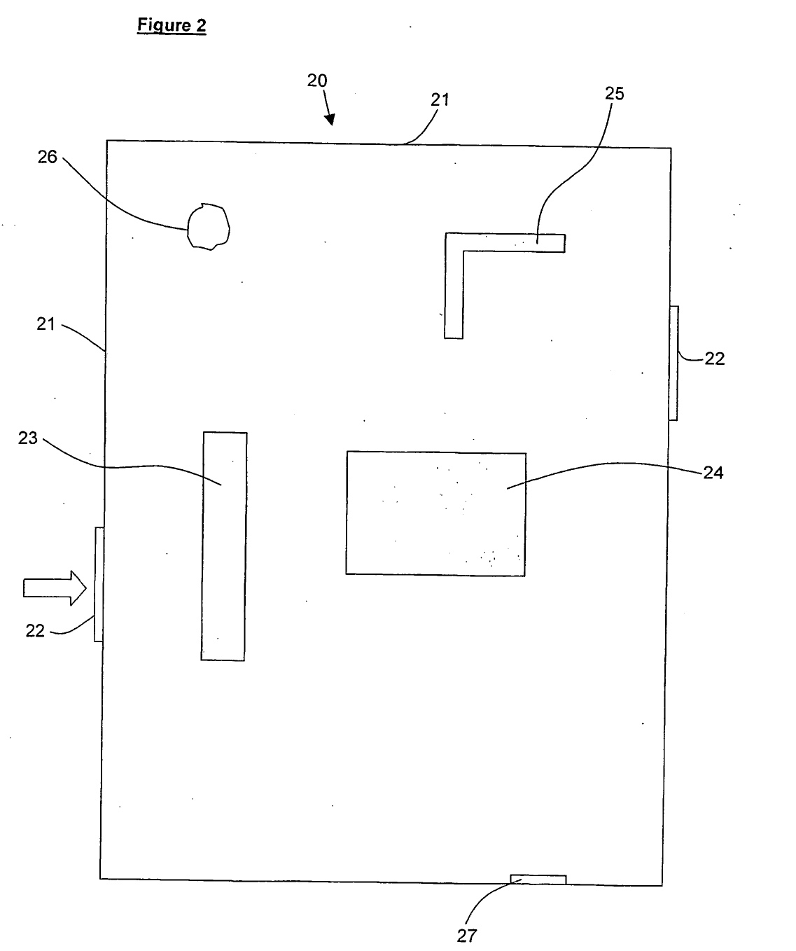

A schematic of a simple virtual world environment is shown in FIG. 2. This represents a room 20, including walls 21, doors 22, and various obstacles 23, 24 and 25 within the room. When specifying the design of this virtual world 20, the content provider inputs data in the form of co-ordinates representing the shape of the environment into the server 2 via terminal 3. The data might include co-ordinates representing a collisionable mesh defining the obstacles 23, 24, and 25 through which a navigating user is not allowed to pass.

Feature Nodes

The content provider is able to define features of interest within the room that a user may wish to view. For example, if the virtual world represents a tour through a historic building, it may be desirable to insert features such as statues, furniture, paintings and information boards. These may be represented by objects within the room, for example statue object 26, painting 27, and information boards (obstacle 25).

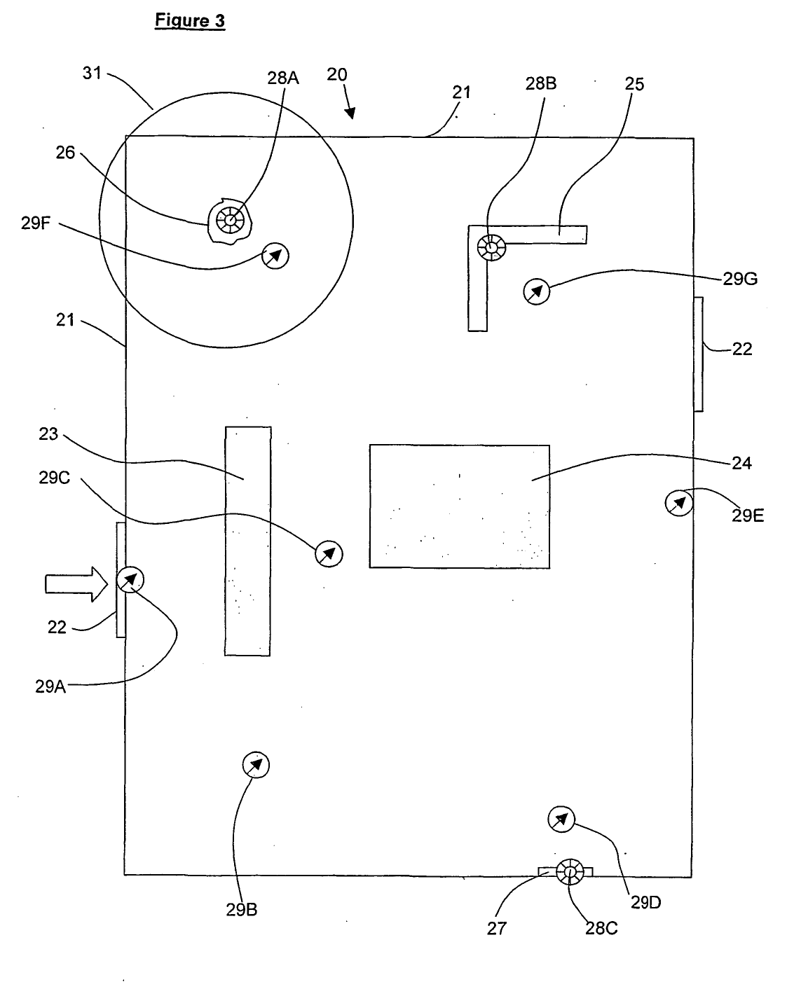

In order that these features may be visited by a user, the content provider defines feature nodes 28A, 28B and 28C (shown in FIG. 3) associated with the features, which the user can view or interact with. A feature node is therefore essentially a point in the virtual world, linked either to an object or to the collisionable mesh, and in the embodiment has the following data set:

Node ID
Feature Group ID
Object ID of the linked mesh/object
XYZ of object pivot point data
Sphere of influence settings
Display settings

Node ID—an unique identifier for the node (e.g. text string “monet_painting_{—}01” or numerical identifier “00563”)

Feature Group ID—an identifier for the type of feature associated with the node, for example all paintings may be in a first Feature Group identified as “paintings”, whilst information boards might be a second Feature Group “information_points”. The choice of groupings is highly dependent on the content provider and the type of features they wish to distinguish within the virtual world.

Object ID of linked mesh/object—this is the identifier for the object or collisionable mesh associated with the feature node, and may be the same as the node ID (e.g. “monet_painting_{—}01”)

XYZ of Object Pivot Point Data—these are the co-ordinates giving the location of the feature node (and may be obtained by extraction from properties of the object/mesh with which the feature node is associated)

Sphere of influence settings—these define (for a 3D world) a three dimensional sphere (for example, illustrated as circle 31 in FIG. 3) surrounding the feature node, and are used during the calculation of navigation paths through the virtual world

Display settings—these are some of the settings to be used for text/images associated with the feature

Navigational Nodes

The content provider also initially defines a plurality of navigational nodes (29A, 29B, 29C, etc) within the virtual world, as shown in FIG. 3. Essentially, these provide a simple matrix of navigational points which the automated path generation algorithm can use to plot a route through the environment. Associated with each navigational node is the following data set:

Node ID
Node Level ID (optional)
XYZ position
LoS data
LoS constraint settings (optional)
FoV constraint settings (optional)
Orientation constraint settings (optional)

Node ID—a unique identifier for the node

Node Level ID—this is an identifier which allows a level for the node to be defined, effectively grouping the nodes into different subsets, and used during the path finding process to split the virtual world into different regions for processing efficiency. For example, two different rooms in the virtual world could be represented by different regions of nodes, with the doorway between them comprising a switch node. For processing efficiency, a path can initially be calculated based on only the nodes of one of the rooms (thus saving erroneously calculating at this stage paths which enter the second room, and only later allowing the pathfinding calculation to extend to the second room via the switch node). Additionally it is possible that the different sub-sets could cover overlapping regions (for example a first level of nodes might provide coarse coverage of a large area while different levels might provide finer coverage of the same area or subsets of that area).

XYZ position—these are the x, y, z co-ordinates giving the location of the navigational node

LoS data—this data field will be empty initially, but is later used to contain a list of all nodes which the present node has Line of Sight (LoS) to, i.e. all the nodes that it is able to link to (See Later for Further Details)

LoS constraint settings—the content producer may choose to manually define an angular LoS constraint (e.g. an angle range, in which the node is only allowed to search for nodes to link to if they fall within that viewing angle, see later for more details)

FoV constraint settings—the content producer may choose to define angular constraints for the Field of View (FoV) which will constrain the range of images allowed to be displayed to a user at that node (e.g. for node 29F, the FoV may be constrained in the angular direction towards statue object 28A to ensure that the user sees the object)

Orientation constraint settings—for some navigational nodes, the content producer may choose to constrain the allowed orientation of the user as they approach the node, by defining orientation constraint settings this forces the calculated path to approach the node from a particular direction.

The content provider is thus able, through the use of navigational nodes, to define key positions within the virtual world from which the potential user is able to best experience the features of interest within the environment. The content provider can define the exact position, direction of approach (orientation settings), and viewing angle (FoV constraint settings) so as to increase the quality of the user's experience of the features of interest, compared with other systems which are completely automated.

Processing

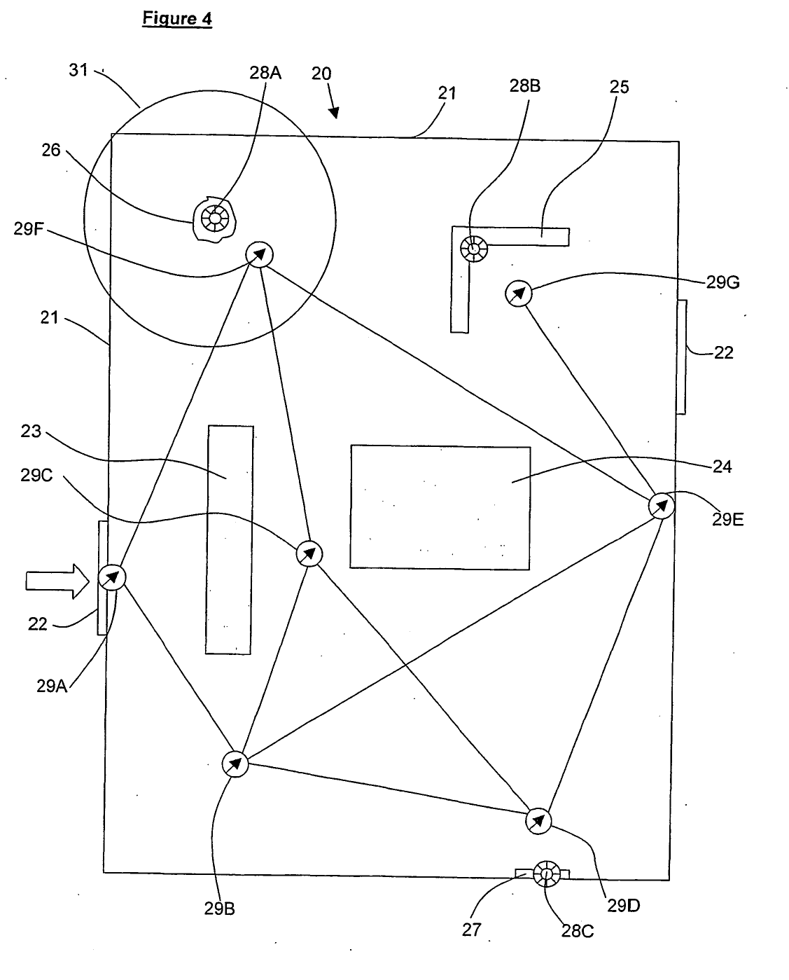

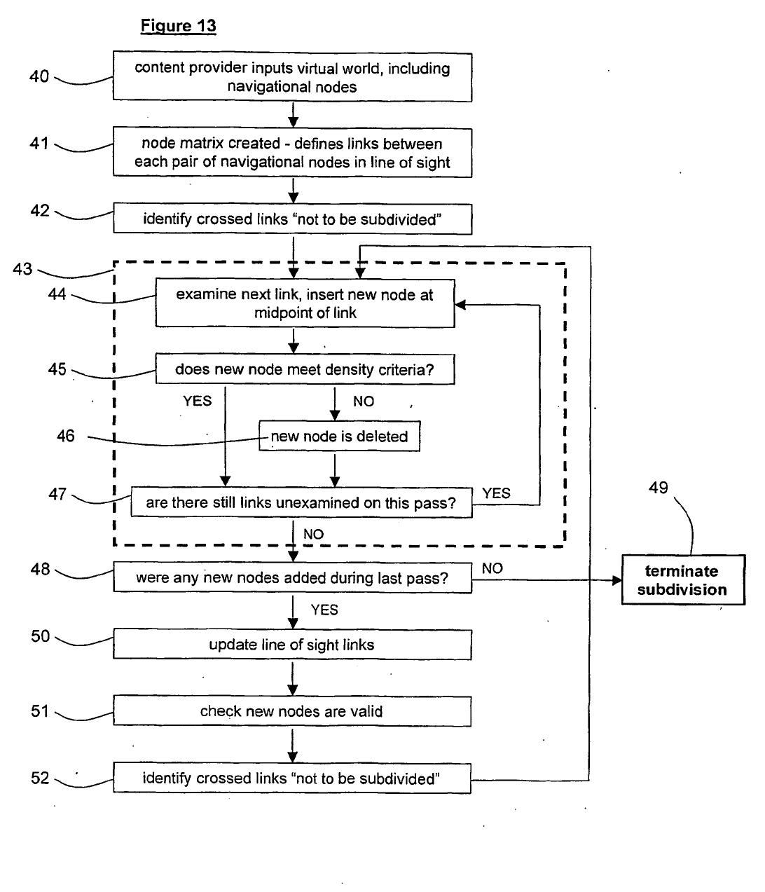

The subsequent processing is explained with reference to the flow diagram in FIG. 13. After node data has been input to the system (step 40), a node matrix is automatically created for the virtual world (step 41). This identifies for each navigational node all the other navigational nodes it is able to link to. Node links are calculated following basic rules of LoS (line of sight) for two nodes. This takes into account the collisionable mesh and any other objects deemed to crop the LoS of the nodes (i.e. no links are allowed to pass through obstructions because a path between nodes cannot pass through these). FIG. 4 illustrates all possible LoS links for navigational nodes in the virtual world 20 (i.e. the lines linking nodes 29A, 29B, etc). For example, Node 29A has direct line of sight to both nodes 29B and 29F, but not to 29C because this would pass through the obstacle 23. A node matrix for virtual world 20 of FIG. 4 is represented in tabular form below:

| | |
|---|---|
| Node | Links to other nodes |
| 29A | 29B, 29F |
| 29B | 29A, 29C, 29D, 29E |
| 29C | 29B, 29D, 29F |
| 29D | 29B, 29C, 29E |
| 29E | 29B, 29D, 29F, 29G |
| 29F | 29A, 29C, 29E |
| 29G | 29E |

At this stage each navigational node's data set is provided with LoS data on all its visible partners, including their XYZ position. Any navigational node which does not have line of sight to any other navigational nodes is deemed invalid and may be deleted from the system.

If the content provider had specified any LoS constraints for particular navigational nodes, then this would crop the angle it is allowed to search for node links. This is controlled using “LoS constraint settings” for the node, comprising degree values which slice the otherwise allowed 360 degree LoS. In this case, the node matrix above would differ as some of the links shown there would not be allowed. This functionality allows the content provider to create channels of nodes that ignore other nodes around them, and to produce breaks in the node matrix where nodes are not desired. This can improve the user experience because in this manner the content provider can influence the routes taken by a user within the virtual world.

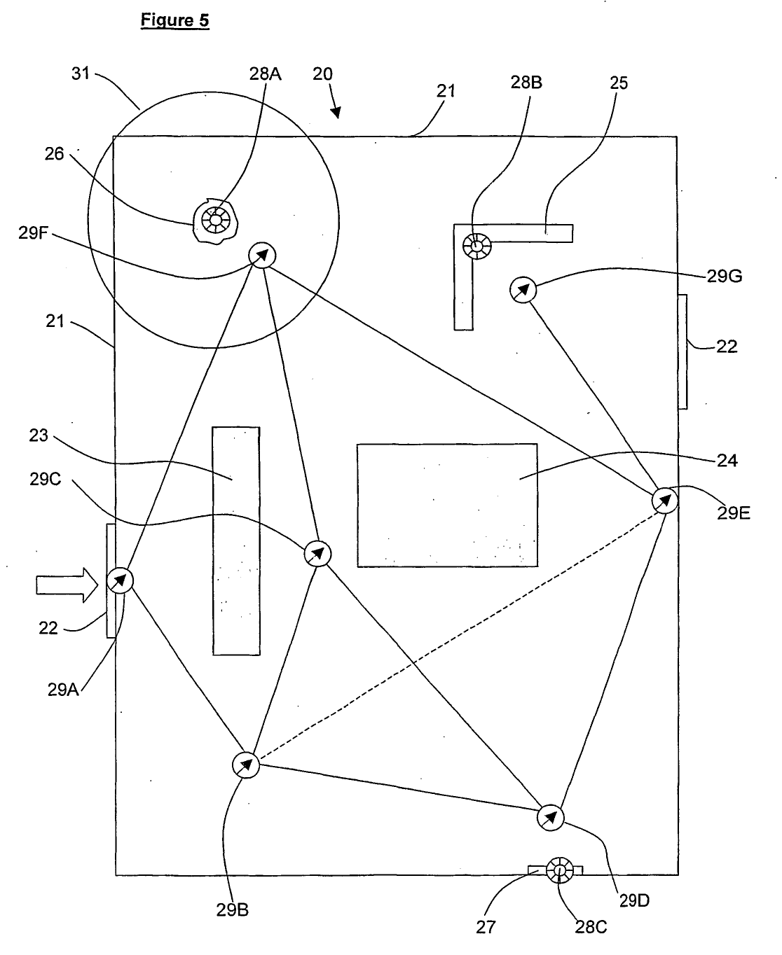

The next stages of processing will add in additional nodes on the basis of the LoS links already defined. However, before that occurs, the system checks all the links (step 42) to decide which links will/will not be used as a base for the new nodes. In particular, the system looks for any crossed links (such as the 29B-29E link which crosses the 29C-29D link), and marks the longest of the crossed links as not being available for use as a base for the new nodes. In this embodiment a data flag is associated with the link (in either the node matrix or the individual nodes' LoS link data) to indicate that this link is “not to be subdivided”. The affected link is shown as a dotted line in FIG. 5.

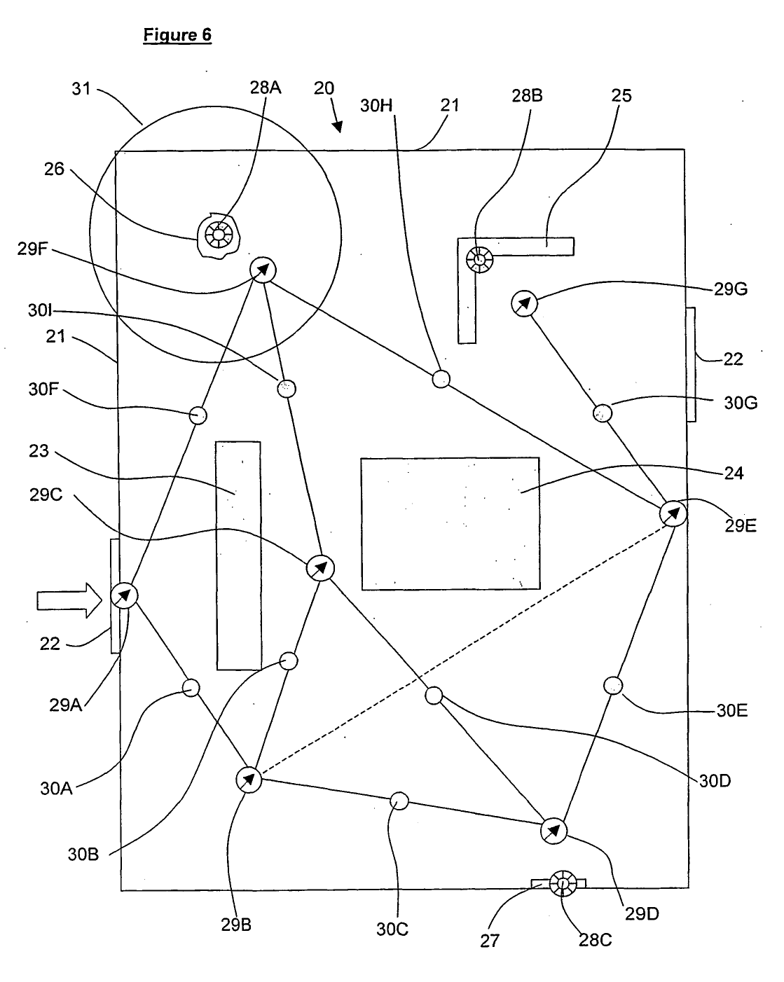

The next stage of processing involves the automatic creation of a more dense matrix of nodes (step 43). This is achieved by subdividing the LoS links between the existing navigational nodes so as to add new navigational nodes (also referred to as subdivided nodes) at each midpoint (step 44). FIG. 6 shows these subdivided nodes (30A, 30B, 30C, . . . etc). As more and more new nodes are added during each cycle through step 43, the density of nodes increases, up to a maximum allowed node density. This density may be predefined in advance by the content provider, for example by specifying a minimum allowed distance from a node to it's nearest neighbour. After each new node is added, the system checks whether the new node meets the density criteria (step 45). If it falls outside the allowed density criteria, the new node is deleted (step 46). Otherwise, the node is kept. Once every LoS link has been examined for subdivision (step 47), the system checks whether any new nodes were added during the last pass (step 48). If no new nodes were created during a pass, the system terminates (step 49).

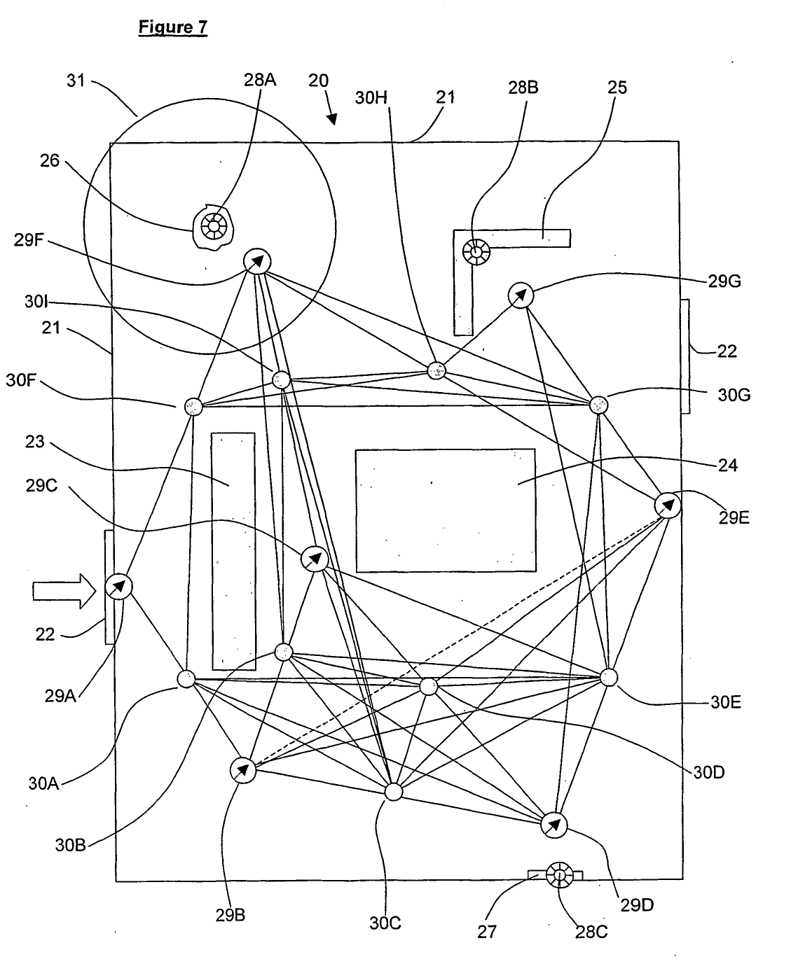

For each pass, after the new nodes have been added, the LoS data for every node (both the navigational nodes and each newly created subdivided node) is updated to take account of all the multiple new possible LoS links (step 50). FIG. 7 illustrates the newly created dense matrix with many more possible LoS links between the nodes.

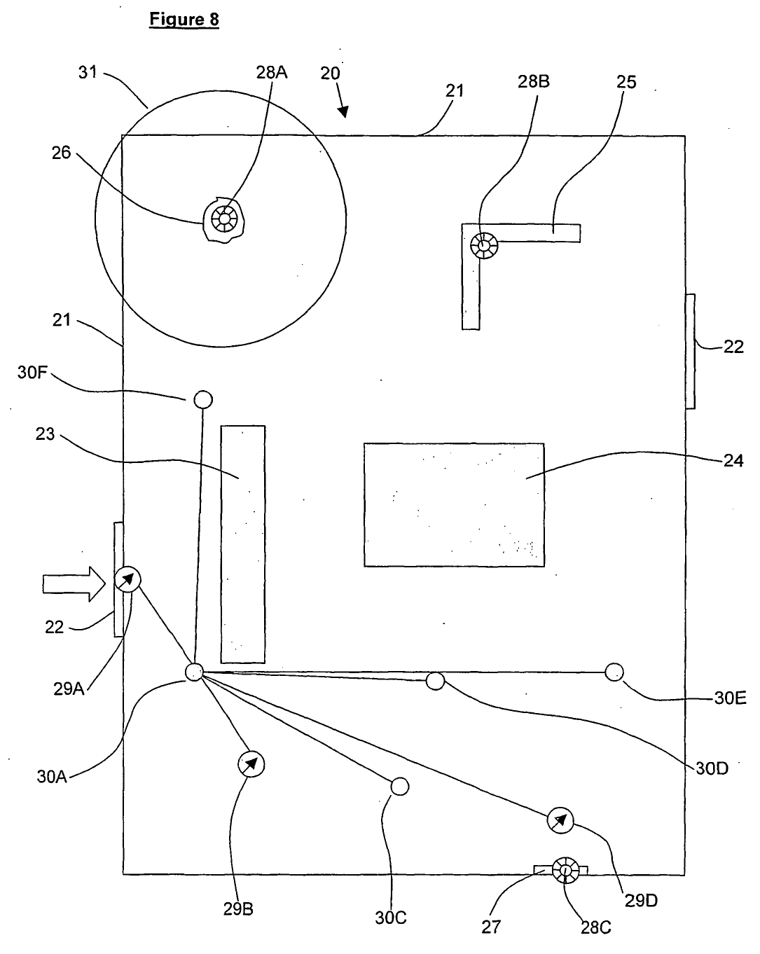

The system now checks which of the newly added nodes are valid (step 51). A node is defined as valid if it links any two other nodes which do not otherwise have line of sight to each other. This is illustrated for node 30A in FIG. 8. In this drawing, for clarity, the only nodes and links illustrated are node 30A and the seven other nodes it links to. It can clearly be seen that node 30A acts as a bridge for many different pairs of nodes (i.e. it forms a connection between two nodes which do not have LoS to each other), such as between nodes 29B and 30F. Therefore node 30A is valid, and in fact only requires that it is connected to one pair of nodes which do not have LoS, to be defined as a valid node. Any invalid nodes are deleted.

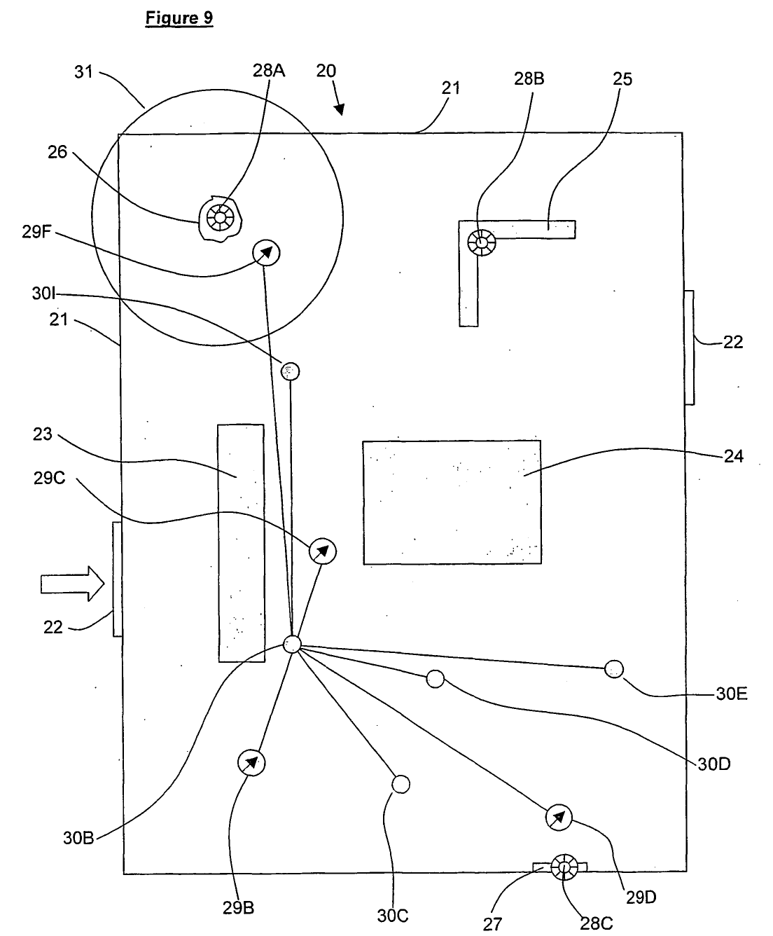

FIG. 9 shows the same procedure for node 30B. Node 30B is defined as valid. However at this stage, any of 30Bs links which do not assist in bridging between two nodes are deleted. This is the case for the link between node 30B and 29C. Since node 29C already has line of sight links to all the nodes shown on FIG. 9 (and reciprocally node 30B also has line of sight to all the nodes linked to 29C), therefore link 30B-29C cannot help to bridge between any pair of nodes that do not have line of sight to each other, and the link 30B-29C is deleted.

Link 30B-30C would also appear from FIG. 9 to be redundant, because node 30C already has line of sight to all the nodes in FIG. 9. However, link 30B-30C is actually valid because it bridges, for example, nodes 30B and 30A (which do not have line of sight to each other) which can be seen from FIG. 7, and therefore link 30B-30C would not be deleted.

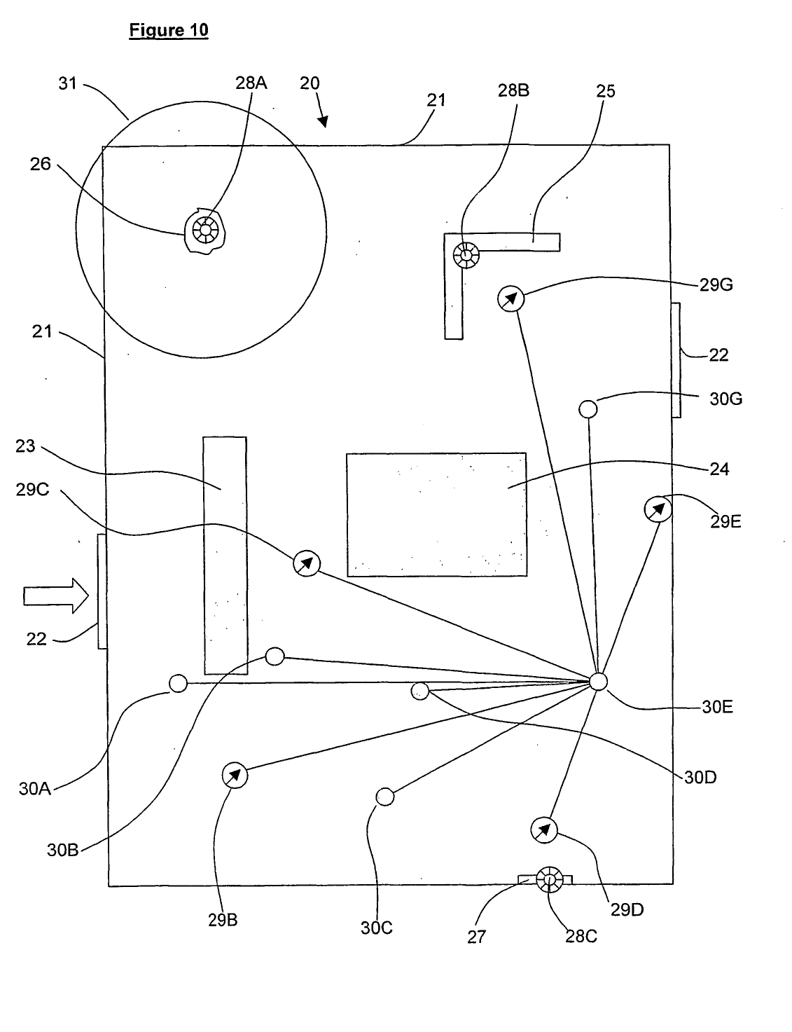

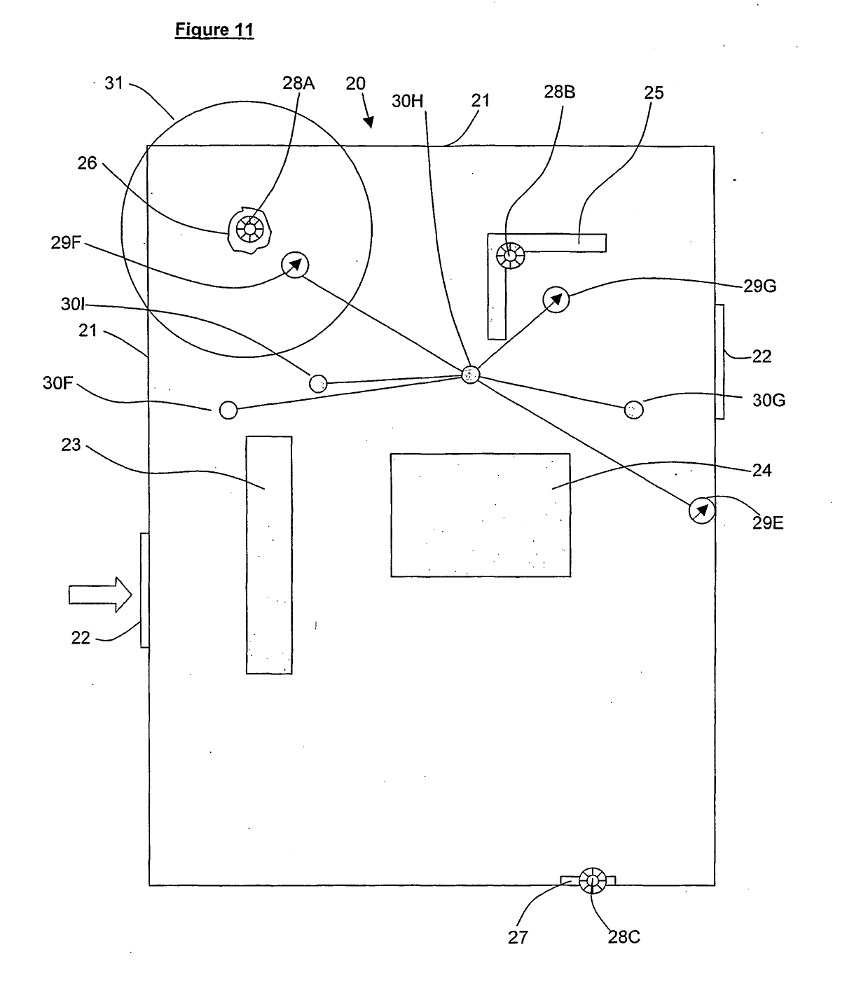

Validity checks are carried out in this manner for all new nodes, and two others (30E and 30H) are shown, in FIGS. 10 and 11 respectively.

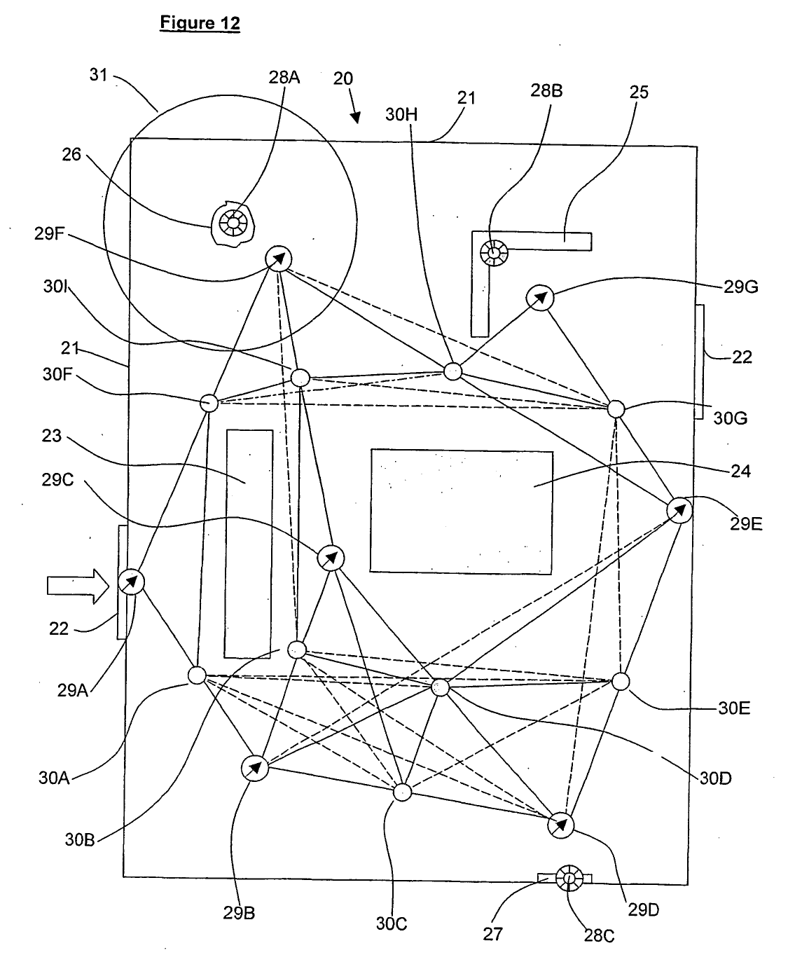

After the validity checks have been performed on the new nodes, the system again checks for any crossed links (step 52). These are the links which are not to be used in any subsequent cycles of subdivision. The links are identified as before, by looking for links which cross each other and flagging the longest ones as “not to be subdivided”. This has been performed for all the links, and the resulting link matrix is illustrated in FIG. 12 (where dotted lines illustrate those links which are not to be used in the future for subdivisions to add more nodes).

Thus one cycle of subdivision has been completed, and even after this, the number of nodes has more than doubled, and the connectivity between the nodes has greatly increased. For example node 29D previously only had links to 29B, 29C and 29E, but is now additionally linked to 30B, 30C, 30E and 30F.

Further cycles of subdivision (step 43) may be repeated, until the system has created a suitably dense matrix of nodes which map out the non-collisionable environment in the virtual world. Advantageously, during the subsequent pathfinding calculation, there is no need to calculate collision data in real time because the matrix nodes are all constrained to navigable areas. In addition, with the higher density of nodes in the environment, the system can generate far more efficient paths than with the originally defined node matrix, and which enhance the user experience by giving a much smoother path through the virtual world which typically follows the type of behaviour a user is used to when navigating a real world environment. Once the path has been calculated a spline is generated to further interpolate and hence to smooth the journey still further. In the present embodiment, once the spline has been generated along a particular path, a default speed along the path is set. In the present embodiment this is set to vary between a fairly fast speed in areas of little interest and to a relatively lower speed around features of interest. Ideally this is done by smoothly varying the speed to have minimum values at the feature nodes of most interest and to have maximum speeds in between these points.

Although in the embodiment above, the node density criteria is specified in terms of the minimum allowed distance between a new node and an already existing node, this could be replaced by any other suitable mechanism for specifying and testing the node density. Another possible method is to specify in advance a maximum allowed number of cycles of subdivision before the algorithm must terminate.

Although in the embodiment above, the check for whether a new node is valid involves checking whether the node acts as a bridge between two other nodes, an alternative/additional criteria which may be used to define whether each newly added node is valid is to check whether the new node assists in providing a shorter path between any pair of nodes.

Pathfinding

As mentioned earlier, the A* algorithm is an optimal pathfinding algorithm both in terms of the processing time required, and the quality of the path found. Start and destination nodes are defined in advance, and the algorithm explores multiple different paths to find the best route from the start to the destination. Consider the case of a user who wishes to tour through virtual world 20, entering at door 22, and who has indicated via a suitable interface that he desires to approach information board 25.

The start node is defined as node 29A, and the destination node as 29G. The A* algorithm operates by maintaining two lists of nodes: a list of nodes that have already been explored (the Closed list) and a list of nodes linked to the ones that have been explored but have yet to be explored themselves (the Open list). The algorithm takes a node from the Open list, and if it is the destination node then the algorithm terminates. If not, all the nodes linked to the chosen node are added to the Open list. The A* algorithm is known as a heuristic method because it uses estimates to guide the search for nodes. In particular, in order to decide which node should be selected next from the Open list, all the nodes have an evaluation function f=cost+heuristic, and the node which is selected as the next current node from the Open list is the one with the lowest value for f.

The cost is a measure of the quality of the path so far from the start node to the current node (i.e. for a simple A* algorithm this could be the sum of the lengths of all the links in the path between the start node and the node). The heuristic function is an estimate of the cost to get from the current node to the destination node. The results of the A* algorithm are very much dependent on the choice of cost and heuristic functions, and it is the specific weighting and cost values used in the evaluation function for the embodiment of the invention that allow the optimum path to be generated.

The cost function of the embodiment takes into account various factors of the route, together with any user specific preferences. The cost function is a weighted sum of the following form:
cost=w1*distance+interest_component+w3*angle
where distance is length of the links so far, and w1 is the weighting ascribed to the current user indicating how important it is to them that the path is as short as possible. Interest_component gives a measure of how interesting the node (s) so far have been (but since we are looking to minimise the cost function, the lower the interest_component value the more interesting the nodes so far have been). Thus, in the present embodiment a summation over the node or nodes included in the partial path built thus far of the form:

$${\sum }_{PARTIAL\_PATH} ( 1 - w 2 * Interest )$$

is used, in which w2 is the percentage weighting interest given to the feature group associated with the node in question, and Interest is a measure of how strongly a node is associated with the corresponding feature associated with the node. Thus, in the present embodiment, feature nodes (typically of great interest to a user) may be given an Interest value 1, whilst navigational nodes have interest value of 0 and therefore when summed as above give a higher cost. As mentioned, weighting w2 gives a measure of how important it is to the user that they visit features of interest of each respective feature group.

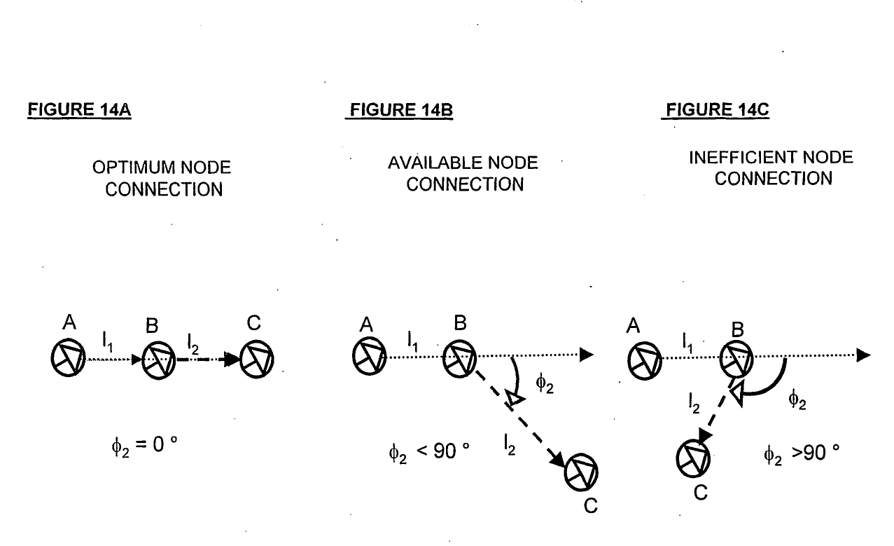

Finally, angle gives a measure of how much the path so far wiggles, since this represents a sum (or average) of how much the angle between the entry and exit links for each node deviates from a straight line. Weighting w3 gives a measure of how important it is for the user that the path wiggles as little as possible (i.e. a zero value of w3 would suggest that the user did not mind how the rate of change of curvature of the path varies as a function of distance along the path (i.e., how wiggledy) the path was whilst a high value (eg 100%) would indicate that the user would prefer to avoid wiggledy paths). This is shown in more detail in FIGS. 14A to 14C of the accompanying drawings.

In FIGS. 14A, 14B, 14C a connection between nodes A and C is established via node B with varying degrees of efficiency. The LoS I₁ between nodes A and B defines an initial reference angle φ₁=0°. The LoS I₂ between nodes B and C subtends angle φ₂ from reference angle φ₁.

Thus in FIG. 14A, the LoS route between nodes A and B has Δφ=φ₂−φ₁=0°, which provides the maximum efficiency. In contrast, the connections shown in FIGS. 14B and 14C are less efficient. In FIG. 14B, Δφ=φ₂−φ₁<90°, whereas in FIG. 14C, Δφ=φ₂−φ₁=0°, =φ₂−φ₁>90°. If the angle of differential is constrained to Δφ<90°, then the node connection shown in FIG. 14B would be available, whereas that shown in FIG. 14C would be inefficient.

According to one embodiment of the invention, the LoS angle differential Δφ between the entry LoS I₁ and the exit LoS I₂, provides an additional weighting for the pathfinding system described herein. The LoS angle differential can also be used to constrain pathfinding in other systems in which it is advantageous if connections between nodes are constrained according to whether a path is to be more or less “wiggly”.

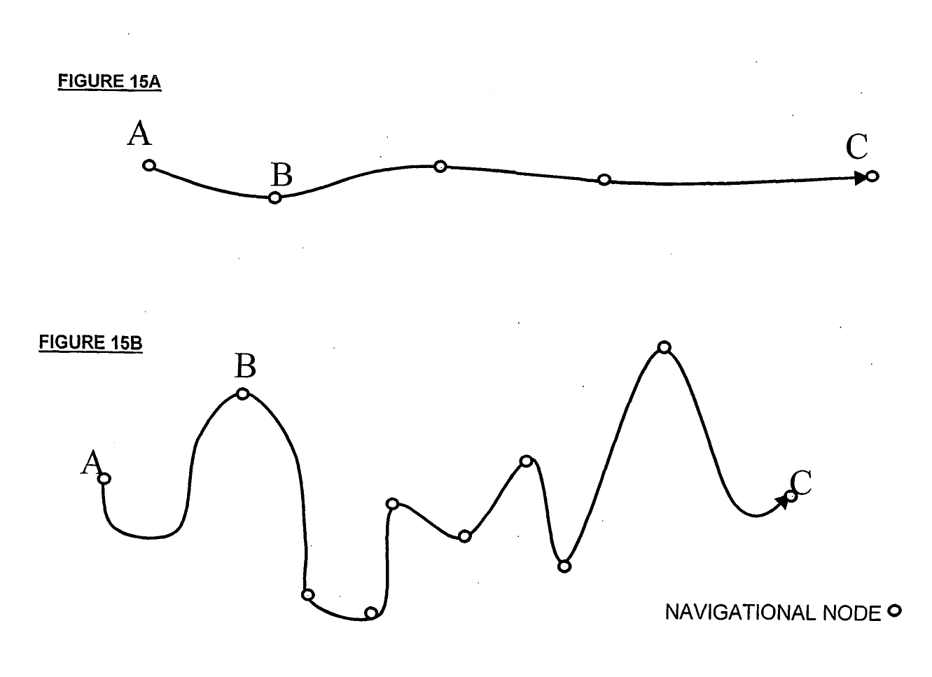

In the embodiments shown in FIGS. 14A to 14C, if the LoS angle differential value Δφ is assigned a highest for Δφ=0° and a Δφ=180° is assigned a low rating, the path finding system will optimise straight connections between nodes A and C. If however, Δφ=0° had the lowest rating and Δφ=90°, for example, the path finding system would find more bendy paths acceptable. This is shown schematically in FIGS. 15A and 15B.

In FIG. 15A a relatively straight path is shown between navigational nodes A and C, whereas in FIG. 15B, a more wiggly path between navigational nodes A and C is shown. The path shown in FIG. 15A is representative of a weight being provided by the LoS angle differential which constrains the path generation to optimise LoS connections between the nodes along the path. In contrast, the path shown in FIG. 15B is representative of a weight being provided by the LoS angle differential which is representative of a weight being provided by the LoS angle differential which constrains the path generation to generate a wiggly path between nodes A and C. Thus, in the examples shown in FIGS. 14A to 14C, as the angle between the first and second line increases, the efficiency of the nodal connection decreases. The rating for each node is processed for the entire path, for example, to determine an average rating for the path which will be dependent on the number of nodes along the path, to determine a line of sight (LoS) angle differential ranking value for each different nodal path between two points.

Whilst the angle differential LoS weighting may be used by a content designer, it is also useful to provide a means for a user of the navigation system to apply a constraint on the angle differential LoS, as this can facilitate the user's orientation as they navigate the virtual environment.

Accordingly, another embodiment of the invention provides a user interface arranged to implement an angle differential navigation constraint. The user interface enables a user to constrain the LoS angle differential ranking value of the path in dependence on one or more preferences determined by the user. This means that the degree of curvature of the path can be constrained so that it does not change too rapidly as the user navigates (or is navigated) along the path, as this could disorientate the user. For example, if the user's view is directed always straight ahead in the direction they are moving, then if the path the user takes were to spiral along in a series of retrograde loops, the user might become very disoriented if they have never taken a particular path before. However, if they were very familiar with the path they were to follow, they might want to be able to follow a path which provides a 360° view of some objects they encounter along the way. Accordingly, it is useful if the user can constrain the path so that either it does not change direction (i.e., bend) too much, or, if it has to change direction, it does not do so too rapidly (i.e., if the rate of any change in the degree of curvature of the path as a function of path difference can be constrained).

Thus by constraining the LoS, a straighter guided path to be provided along which the user is automatically navigated according to the pathfinding system employed. This can enhance the user's experience as the user is able to retain more of a sense of direction. Moreover, by constraining the angle differential of the LoS of the guided path along which the user is automatically navigated by the system, the FoV that the user has can also be constrained to enable the user to be less disorientated by the number of feature nodes the path encounters and approach taken towards certain feature nodes. If more bendy (i.e., higher degree of curvature) automated path navigation was selected by the user, then the user's speed along the path might be reduced to help the user retain their sense of direction. Alternatively, the user's speed can be reduced when the rate at which the degree of curvature of the path increases, so that when a user navigates along a very “wiggly” path, their progress is slower than when the path is straight or less curved. If a user has a higher degree of familiarity or is better able to cope with a more curved path, or a path in which the curvature changes more rapidly, they can change the LoS constraint so that a more bendy path is generated.

The more bendy path can enable the user to see more features from different directions possible, and even loop around certain features. This may be advantageous if a user has already navigated a path from A to C (as, for example, is shown in FIG. 15A). In this case, the user may be somewhat familiar with the objects they have encountered along that path and be able to recollect some aspects of their configuration. In this respect, the user will now be familiar to some extent with the topology of the virtual world. If, however, the user wants to be automatically navigated from A to C but see more sights along the way. As the user is more familiar/better able to cope with the virtual environment (for example, a path may be more wiggly if an adult is exploring than if a very young child is exploring), the user is able to retain their sense of orientation despite several changes in direction and a more wiggly path can be followed if the user assigns a relatively high LoS angle differential ranking for the navigational nodes along the guided path.

Such a constraint can also be implemented using the user profile described in more detail later below.

The heuristic is an estimate of the cost to get from the current node to the destination node, and one possible choice for this is:
heuristic=euclidian_distance_to_destination
The heuristic in the embodiment is therefore based on the Euclidian distance to destination (i.e. a straight line from the current node to the destination node), although it could alternatively also include some measure of the distance, interest and angle weightings w1, w2 and w3 if desired.

The system therefore runs through the A* algorithm for the nodes using the evaluation function, until the final destination node is reached. Importantly, the weightings w1, w2, and w3 can be varied depending on the user profile.

Defining a User Profile

A suitable interface (not shown) allows the user to define their profile (e.g. what they are particularly interested in, and how they like to navigate through the virtual world). The user profile settings are then incorporated into the weightings above used for the A* algorithm, which consequently will result in different paths being generated for different users. The translation of the user interests into weightings allow different routes to be compared against each other such that the optimum path for that user can be generated. It can be seen that for a user who is particularly interested in visiting features of interest (paintings, landmarks, etc) it is likely to be the case that the system will not calculate the quickest or shortest route between two points. Rather, the lowest cost path (i.e. the best route for that user) will be one which visits as many features of interest as possible.

The user may input their profile upon first entering the virtual world. Some options include:

| | |
|---|---|
| Always select shortest path | on/off |
| Always select quickest path | on/off |
| Ignore all features | on/off |
| Gaze orientation | on/off |
| Velocity control | on/off |
| Importance of path being short (w1) | weighting |
| Importance of path not being wiggly (w3) | weighting |
| Importance of visiting Feature Group 1 [e.g. paintings] (w2) | weighting |
| Importance of visiting Feature Group 2 [e.g. information | weighting |
| points] (w2) | |
| Importance of visiting Feature Group 3 [e.g. landmarks] (w2) | weighting |

The first five options are overrides, and are thus non-weighted. For example, if the user selected “Always select shortest path” as ON, then the weighting w2 for the features of interest become irrelevant and will be set to zero.

The final five options are all weighted, and however the weightings are distributed they should all be normalised (e.g. add up to 100% in total). Any option which is not important to the user and not given a weighting is deemed irrelevant and not taken into account in the pathfinding process.

Dynamic Navigational Nodes

In addition to the fixed navigational nodes (29A, 29B, 29C, etc), defined initially by the content provider, the system may also include dynamic navigational nodes (not shown). These nodes operate like navigational nodes in the sense that they can form part of the path generated for the user, but provide enhanced functionality because the user is able to move them. A dynamic navigational node is associated with an interactive mesh object in the virtual world environment that can be moved around by the user. The user is able to specify that they want the dynamic navigational node to be a destination point, and the path will be calculated to it's location.

If a dynamic navigational node is placed a large distance from other navigational nodes, then the subdivision process described earlier may be used to fill in new nodes until a suitable node density is achieved in that area. This then allows a smooth path to be calculated to the node.

If a dynamic navigational node is placed without a line of sight to any other navigational nodes (i.e. in a blind spot) then the node is defined as invalid—lost from the Node Matrix (although still present in the environment) and the user is prevented from selecting it as a destination. Alternatively, the system may prevent the user from placing the node in a blind spot, and only allows it to be moved into valid positions.

Switch Navigational Nodes

In addition to the fixed navigational nodes and the dynamic navigational nodes, the system may also include switch navigational nodes (not shown), defined by the content producer. As mentioned earlier, navigational nodes have a Level ID, specifying which level the node belongs to, and effectively grouping the nodes into different subsets for more efficient path calculation. For example, if the virtual world consists of two different rooms, then the navigational nodes in one room may be defined as belonging to one level, and the navigational nodes in the second room to a different level. During the pathfinding process in one room, only the nodes of that level are evaluated, saving takes into account nodes on a different level. The switch nodes then provide the functionality to swap from one level to the second level (e.g. the switch navigational node might be positioned in a doorway between the two rooms).

Associated with each switch navigational node is the following data set:

Node ID
Node Level ID #1
Node Level ID #2
XYZ position
LoS data
Switching data

Node ID—an identifier for the node

Node Level ID #1—the identifier for the first level

Node Level ID #2—the identifier for the second level

XYZ position—these are the x, y, z co-ordinates giving the location of the switch navigational node

LoS data—this gives the data for all nodes (for both levels) which the present node has Line of Sight (LoS) to

Switching data—gives the criteria of when the generated path can/cannot switch from navigational nodes on one level to nodes on the other level

Event Feature Nodes

As described earlier, the content provider is able to define feature nodes (28A, 28B, 28C, etc) associated with the features of interest in a virtual world. The content producer is also able to define event feature nodes (not shown) which have the extra functionality that they react to users within the virtual world, or are only active at certain predefined times.

These event feature nodes expand the functionality of the system into the gaming and interactive online environment platforms, where multiple users can interact with the environment and with each other (e.g. the Event Feature may simulate an explosion, or the opening and closing of an interactive chat-room/race event. The content provider must specify when the event feature will be active/inactive, or what triggers it will respond to. An example data set is as follows:

Node ID
Feature Group ID
Trigger data
XYZ of pivot point data
Sphere of influence settings
Time settings
Display settings

Node ID—an identifier for the node (e.g. text string “explosion”)

Feature Group ID—an identifier for the type of feature associated with the node

Trigger data—the conditions which will cause the event feature node to become active

XYZ of Pivot Point Data—these are the co-ordinates giving the location of the event feature node

Sphere of influence settings—these define (for a 3D world) a three dimensional sphere surrounding the feature node. However, in addition to the settings used for the standard feature nodes, these additionally include a time dependant feature which may allow the sphere of influence to degrade over time.

Time settings—these define when the event feature node will be active/inactive

Display settings—these are the settings to be used for text/images associated with the feature when constrained

Further Functionality

As explained above, the processing and pathfinding stages result in a spline path which will be used to take the user through the environment. The spline path therefore comprises a plurality of nodes each joined by links to the next node. The system applies smoothing to this path by interpolating the spline so as to improve further the user experience.

During real time display, when the user is guided through the environment they have the further option to control their field of view. As discussed earlier, the content provider can specify particular angles of viewing (FoV constraints) which are to be applied for specific feature nodes so as to ensure the user does not miss features of interest. The user can choose to toggle control to either operate this automatic field of view presentation or alternatively to control manually their own field of view.

In the embodiments described above, it is explained that the processing stage which creates the more dense matrix of nodes occurs after the content provider has defined the contents within a virtual world, but before the system is used by a user desiring to navigate within that world. It is of course alternatively possible for either part or all of the processing stage which adds these subdivided nodes to be carried out in real time whilst the system is in use by a user. Indeed, an alternative arrangement is particularly desirable when the virtual world contains a number of dynamically moving objects (for example, a virtual environment of a city might include moving cars, buses, etc). In this dynamic case, only some subdivision (for the regions of the world containing static objects such as buildings, etc) could be carried out in advance before a user accesses the system, with the remaining processing to add the extra nodes occurring each time a user specified that they desire a path to be created. The later processing stage thus takes into account the positions of these dynamic objects at the instant the user desires the path to be created. This functionality could be supplemented by defining some regions in the world in which this later (dynamic) subdivision will occur (for example, streets within a virtual city), and other regions in the world when the dynamic subdivision will not occur because they typically contain only stationary objects (for example, the insides of some buildings). This is a typical example when switch nodes (mentioned above) might be used to delimit the node links between different regions.

Furthermore, it may be necessary in real time to create new nodes corresponding to the start and destination points selected by a user for a path generation procedure. If nodes do not already exist at these locations then the system may be used to automatedly create such nodes, and additionally use processing to add new subdivided nodes in only the regions close to the start and destination nodes so as to link them to the already existing node matrix.

This invention enables the overall ranking for each prospective node path from the start to the destination points of a guided path to incorporate a rating based on the LoS Angle Differential. The LoS Angle Differential rating is first normalised, however, to enable the weighting indicated in a User Profile to influence the path ratings. After the set values within a VW have been weighted against the user settings the actual path rating calculation is performed.

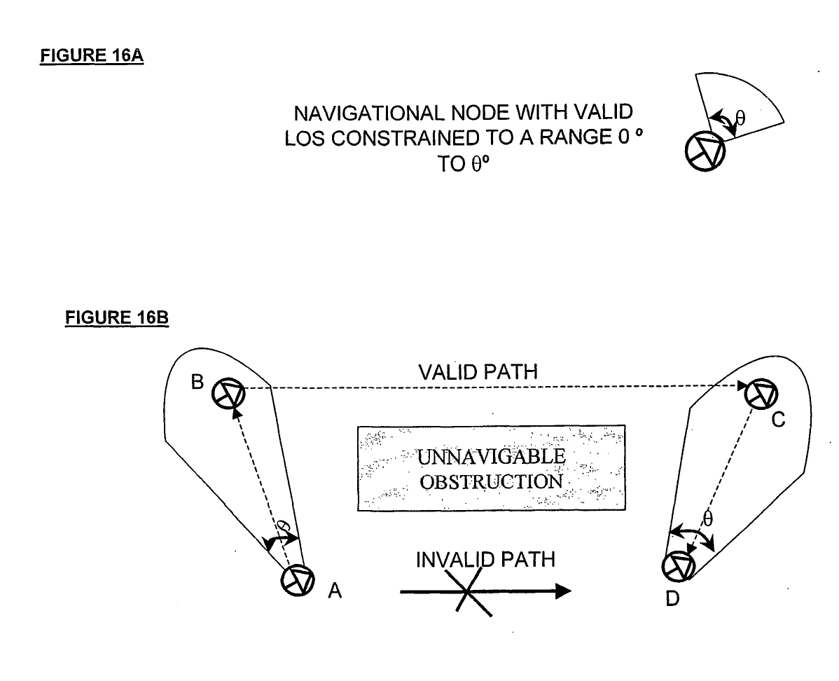

The LoS Angle Differential also enables the content producer of a VW to manually define constraints to the LoS angle between nodes to crop the angles which are searched for node partners without the need for a collisionable mesh, such as is shown in FIG. 16A.

FIG. 16A shows a navigational node for which a valid LoS angle to or from another node is constrained to a range of angles between 0° and θ°, where θ<360° (θ°=360° would remove the range constraint for the LoS angle between nodes.

This functionality allows the creation of channels of nodes that ignore other nodes around them which produces a break in the node matrix where links are not desired FIG. 16B shows how this may modify the LoS between two navigational nodes A and D, so that instead of a path being generated along a LoS connection between A and D, the pathfinding system instead generates a path via navigational nodes B and C. Navigational node B is positioned within the range of exit angles for navigational node A, whereas navigational node C is positioned between the range of entry angles for influence of node D.

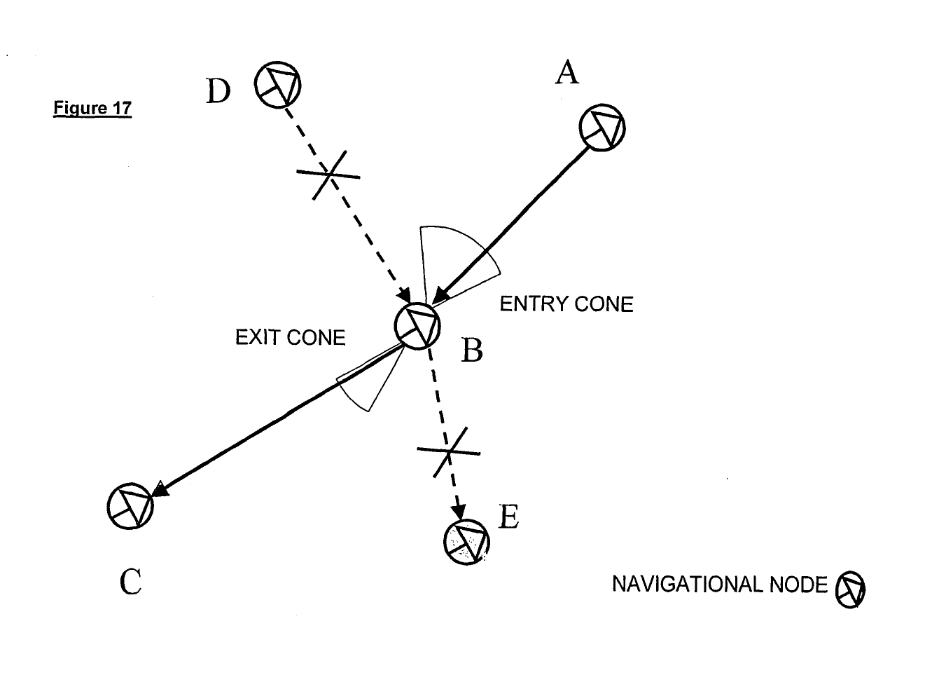

It is possible for a node to have both a range of entry angles (and “entry cone”) and a range of exit angles (an “exit cone”) such as FIG. 17 shows for node B. An additional LoS constraint allows the content producer to create a first LoS “cone” which defines a range of angles that the first LoS line to the previous node on the path must enter through, and a second LoS “cone” which defines a range of angles through which a second LoS to the next node along the path must exit the node.

In FIG. 17, the pathfinding system is generating a path between nodes A and C, and node B is constrained in that it can form connections only with nodes within its entry and exit cones. Thus in FIG. 17, the LoS between node A and node B falls within the entry cone for node B. Similarly the LoS between node B and node C falls within the exit cone for node B. However, the LoS between node D and node B and the LoS between node B and node E lie outside the range of permitted approach and exit angles for node B. Accordingly, the dashed lines between nodes D and B and B and E are invalid connections.

The LoS constraint shown in FIG. 17, can be implemented as a modified version of the LoS Angle Differential constraint/weighting system described herein above with reference to FIGS. 14A to 14C and 15A and 15B of the accompanying drawings. For example, the range of angles of a second LoS cone (exit cone) is determined as a function of the LoS Angle Differential and the range of angles of a first LoS cone (entry cone), or vice versa in some embodiments of the invention.

Whilst the above embodiment of the invention has been described in the context of a pathfinding system suitable for plotting a guided path along which a user is automatically navigated in a virtual environment, the implementation of applying a weight to a pathfinding system which is based on the extent to which the path bends can be used in other systems in which a user wishes to plot a path, for example systems which enable the user to navigate across land and/or sea environments. In particular, where a user is implementing a system using global positioning satellite technology or the like, especially where the environment enables the user can determine a path which follows a relatively unconstrained route, the invention can be used to provide the user with a scenic route (for example, one which meanders across a desert or island-hops in a sea-environment) or a direct route (which might be more efficient in terms of fuel economy).

Sphere of Influence Settings

The sphere of influence settings in the present embodiment specify a centre point (by means of a triplet in 3D (or a pair in 2D) of virtual co-ordinates) of the sphere of influence and a radius of influence. Typically, but not necessarily, the centre point will coincide with the location of the centre point of the object/mesh with which the feature node is associated).

In the present embodiment, the sphere of influence settings are used for at least two distinct functions. Firstly they are used to help select a path which accords with a user's profile definition. Secondly, they are used to influence the view seen by an entity travelling through the environment, especially when travelling along a generated path in an automated manner. Additionally, they may be used to alter the final splined path generated through a set of selected nodes (in such a way as to pull the final splined path in towards the centre of any spheres of influence which the spline passes through). Also, they can be used in addition to or instead of the mechanism used at the time of spline generation for varying the guided speed at which an entity will travel along the guided path; for example, as the entity is travelling along the guided path, its speed of progress along the path could be further slowed whenever the entity enters a sphere of influence, by an amount which depends on the relative distance from the edge of the sphere (or region) of influence towards the centre of the sphere (or region) of influence.

Path Generation

Although not explicitly illustrated in the above example, the sphere of influence settings are used in the present embodiment to affect the generation of a path. This is done by determining if any of the navigational or sub-divided nodes fall within the sphere of influence of a feature node (or of an event feature node). For example, if the sphere of influence 31 (as shown in FIGS. 3 to 12) were slightly bigger, it might encompass navigational nodes 30F and/or 301.

In the present embodiment, any navigational or sub-divided nodes which fall within the sphere of influence of a feature node (or an event feature node) are given an interest (stored in an interest field) which varies between 1 and zero according to the proportionate distance from the centre of the sphere of influence (with the centre of the field giving rise to an interest value of 1 and the perimeter of the sphere giving rise to an interest of 0). Additionally, each such node is given a Feature Group ID (which is stored in a Feature Group ID field) and which takes the same value as that of the feature node associated with the sphere of influence in which the navigational or sub-divided node is located. In the present embodiment this is done in a fairly smooth manner by calculating a radial function which varies smoothly (with, for example, an integer percentage value as the level of coarseness) from 0% at the perimeter of the sphere of influence up to 100% at the centre of the sphere of influence; however, as an alternative a much coarser method could be used, for example by assigning an interest of 0.25 to any node falling within a distance greater than half the radius of the sphere of influence away from the centre point of the sphere of influence up to the perimeter of the sphere of influence and a value of 0.75 to any node falling between the centre of the sphere of influence and a distance up to half the radius of the sphere of influence away from the centre point of the sphere of influence.

In alternative embodiments, the manner in which the interest of a navigational or sub-divided node should be assigned an interest value in dependence on its distance from the centre of the sphere of influence may be specified explicitly as an additional sub-field or set of sub-fields within the sphere of influence settings of the corresponding feature (or event feature) node.

In the present embodiment, in the event that a navigational or sub-divided node is located within two (or more) “competing” spheres of influence, then a procedure is followed to choose one over the other. Firstly, a level of influence is calculated for each sphere of influence by dividing the radius of influence by the (Euclidean) distance of the navigational or sub-divided node from the centre of the sphere of influence and then multiplying this by the weighting (if any) ascribed to the feature group to which the sphere of influence belongs in respect of both (or all) competing spheres of influence. If one level of influence calculated in this way is greater than the other (or others) then this one is selected. Otherwise one of the spheres with an equally high level of influence is selected at random.

Field of View Constraint Settings

In the present embodiment, the sphere of influence settings also include field of view constraint settings which act to constrain the field of view of an entity (such as the avatar of a user) when travelling through a sphere of influence in a guided mode. A guided mode is one in which an entity (eg the avatar of a user) is automatically moved through the virtual world according to a generated path rather than moving under the direct control of a user (for a full discussion of this mode, see co-pending patent application having the same filing date as the present application with the same applicants and inventors and Agent's reference A30471). When in this mode, as soon as the guided entity enters a sphere of influence, the corresponding feature node is examined to see if it specifies any field of view constraint settings. If so, the field of view parameter is recalculated according to the stored field of view constraint settings. Typically these will be set to ensure that the view seen by the user whose entity is being guided through the virtual world will include the feature within whose sphere of influence the entity is travelling. In the event that the entity passes through a region of overlapping spheres of influence, then one sphere of influence will be chosen as the dominant one in the manner described above. Naturally this may cause an entity's field of view to switch between two different settings as one sphere comes to dominate over another etc. Alternatively, the system could encourage the field of view to switch between two (or more) competing fields of view so that the user will see all of the features whose sphere of influence its entity passes through in guided mode (with a suitable algorithm being used to allocate less viewing time to the sub-ordinate feature whilst ensuring that, where possible, the competing views get to come out on top as the user's entity passes most closely to the corresponding feature). A second alternative, intermediate the above two possibilities, is to set a threshold of interest difference such that the field of view switches between two (or more) competing features only if the difference in the levels of influence of the two (or more) competing spheres is less than the threshold amount (which could be user set or set to some default value).

Another enhancement to the field of view constraint settings is to specify a cut-off angle at which the field of view switches back to look at the direction of travel rather than the associated feature even whilst still within the sphere of influence once the angle of deviation away from the straight on direction of the feature has increased beyond, for example, 90 degrees or some other specified angle (which could be set to depend upon the speed at which the entity is travelling along the path and/or the level of influence, etc.).

Application to Real world Environments

It will be apparent that the use of regions of influence to help generate paths through an environment is applicable to real world situations as well. For example, in an application to help choose a route for a car driver between an origin and a destination along a country's road system, a model of the real world environment can be formed in which a navigational node is formed at each junction (i.e. T-junction, cross-roads, roundabout etc.) between two or more roads, and feature nodes are specified at points along a road which are associated with features such as buildings, landscape features, petrol stations, etc. Regions of influence can then be set in exactly the same way as described above and a route along a number of nodes from the origin to the destination can be searched for as before, taking into account any features of interest to the user (i.e. the car driver).

Those skilled in the art will appreciate that the scope of the invention is determined by the appended claims, and that where a feature known to those skilled in the art is an apparent equivalent of a feature described herein, a feature described herein should be interpreted as synecdoche for all equivalent features. The features described herein with reference to particular embodiments may be combined with any particular aspect and with other features in any appropriate manner apparent to those skilled in the art.

1. A method of determining a path along some of a plurality of points in a virtual environment comprising a plurality of initially defined points, and obstructions through which the path cannot pass, and in which two points are said to have line of sight if a straight line link between the two points does not pass through any of the obstructions, the method comprising:
(a) selecting a start point and a destination point for said path in said virtual environment;
(b) dynamically redefining the topology of the virtual environment by generating a plurality of additional points, wherein said plurality of additional points are generated by repeating the following step:
defining a new point located on a line of sight link between two existing points;
(c) calculating the path based on any combination of new and/or initially defined points between said start point and said end point.

2. A method as claimed in claim 1, wherein said step of dynamically redefining the topology of the virtual environment comprises increasing the density of the nodal mesh density between said start point and said end point compared to the density of the nodal mesh prior to the selection of a start point and an end point for said path.

3. A method as claimed in claim 1, wherein said virtual environment comprises a representation of a virtual world.

4. A method according to claim 1, wherein the new point is located on the mid point of the link.

5. A method according to claim 1, further comprising in (b) the step of:
deleting the new point if it is less than a predefined distance from another of the points.

6. A method according to claim 5, wherein the predefined distance varies in different regions of the virtual environment.

7. A method according to claim 1, further comprising identifying a link as not being suitable for providing the location for a new point if said link intersects another one of said links which is shorter.

8. A method according to claim 1, further comprising deleting a new point if it does not have line of sight to each of a pair of points which do not have line of sight to each other.

9. A method according to claim 1, further comprising deleting a new point if it does not form part of a path between two other nodes that is shorter than the shortest path which would exist between said two points without said new point.

10. A method according to claim 1, further comprising receiving an indication from a user that they desire a path to be calculated, and wherein said step (b) occurs after said indication has been received.

11. A method according to claim 10, in which the virtual world comprises a plurality of regions each containing one or more points, and in which the step (b) is performed in relation to one or more of the regions prior to receiving said indication, and step (a) is performed in relation to other one or more of the regions after said indication has been received.

12. A method according to claim 11, in which said other one or more regions contain obstacles which move within the virtual environment.

13. A method according to claim 11 in which said other one or more regions contain a point which has been created by the user as representing the start or the destination point for said path.

14. A method according to claim 1 further comprising defining one or more feature entities within the environment having associated regions of influence, and calculating interest values in respect of at least some of the points in dependence upon whether or not they fall within a region of influence, wherein the step of calculating the path takes into consideration the interest values.

15. A method according to claim 14 wherein the or each interest value varies in inverse dependence upon the Euclidean distance of the respective point from the centre of the respective region of influence.

16. A method of determining a route along some of a plurality of points in a representation of a real or virtual environment the method comprising:
(a) defining one or more feature entities within the environment having associated regions of influence;
(b) calculating interest values in respect of at least some of the points in dependence on whether or not they fall within a region of influence; and
(c) calculating the route based on the interest values calculated in step (b).

17. A method of controlling the field of view of a virtual entity travelling through a virtual world, the method comprising associating with one or more other virtual entities a region of influence and generating a field of view parameter in respect of the travelling virtual entity which controls the field of view associated with the entity as it travels through the virtual world wherein the field of view parameter is calculated in a manner which depends upon whether the virtual entity is within or without a region of influence.

18. A system for storing a representation of a virtual world, the representation comprising a plurality of initially defined points, and obstructions through which the path cannot pass, and in which two points are said to have line of sight if a straight line link between the two points does not pass through any of the obstructions, the system being arranged to determine a path along some of a plurality of points in said representation by
(a) defining a plurality of additional points by repeating the following step:
defining a new point located on a line of sight link between two existing points
(b) calculating the path based on any combination of new and/or initially defined points.

19. A system according to claim 18, wherein the new point is located on the mid point of the link.

20. A system according to claim 18, further arranged in (a) to:
delete the new point if it is less than a predefined distance from another of the points.

21. A system according to claim 20, wherein the predefined distance varies in different regions of the virtual world.

22. A system according to claim 18, further arranged to identify a link as not being suitable for providing the location for a new point if said link intersects another one of said links which is shorter.

23. A system according to claim 18, further arranged to delete a new point if it does not have line of sight to each of a pair of points which do not have line of sight to each other.

24. A system according to claim 18, further arranged to delete a new point if it does not form part of a path between two other nodes that is shorter than the shortest path which would exist between said two points without said new point.

25. A system according to claim 18, further arranged to receive an indication from a user that they desire a path to be calculated, and wherein said step (a) is performed after said indication has been received.

26. A system according to claim 25, in which the virtual world comprises a plurality of regions each containing one or more points, and in the system is arranged to perform step (a) in relation to one or more of the regions prior to receiving said indication, and to perform step (a) in relation to other one or more of the regions after receiving said indication.

27. A system according to claim 26 in which said other one or more regions contain obstacles which move within the virtual world.

28. A system according to claim 26 in which said other one or more regions contain a point which has been created by the user as representing a start or destination point for said path.

29. A system according to claim 18 further including: storage means storing a plurality of data groups, each of which stores data associated with a feature entity within the representation including data defining a region of influence associated with the feature entity; calculation means for calculating interest values in respect of at least some of the points in dependence upon whether or not they fall within a region of influence; and processing means for generating a route along a plurality of the points in dependence upon the interest values.

30. Apparatus for generating a route along a plurality of nodes in a representation of a real or virtual environment, the apparatus comprising:
(a) storage means storing a plurality of data groups, each of which stores data associated with a feature entity within the representation including data defining a region of influence associated with the feature entity;
(b) calculation means for calculating interest values in respect of at least some of the nodes in dependence upon whether or not they fall within a region of influence; and
(c) processing means for generating a route along a plurality of nodes in dependence upon the calculated interest values.

31. Apparatus for controlling the field of view of a virtual entity travelling through a virtual environment, the apparatus comprising:
(a) storage means storing a plurality of data groups, each of which stores data associated with a feature entity within the representation including data defining a region of influence associated with the feature entity; and
(b) processing means for generating a field of view parameter or set of parameter in respect of the travelling virtual entity which controls the field of view associated with the entity as it travels through the virtual world wherein the field of view parameter or set of parameters is generated in a manner which depends upon whether the virtual entity is within or without a region of influence.

32. A method of determining a path along some of a plurality of points in a virtual environment comprising a plurality of initially defined points, and obstructions through which the path cannot pass, and in which two points are said to have line of sight if a straight line link between the two points does not pass through any of the obstructions, the method comprising:
(a) selecting a start point and an end point for said path in said virtual environment;
(b) dynamically redefining the topology of the virtual environment in the vicinity of said start point and said end point and the region between said start point and said end point by generating a plurality of additional points, wherein said plurality of additional points are generated by repeating the following step:
defining a new point located between a first existing point and a second existing point, wherein a first line between the first point and the new point and a second line between the new point and the second point do not pass through any of the obstructions; and
(c) calculating the path based on any combination of new and/or initially defined points, wherein the angle of deviation of the first line to a line between the first and second points is constrained.

33. A method as claimed in claim 32, wherein the constraint is imposed by assigning a varying angle of deviation cost value in dependence on the angle to which the first line deviates from the second line.

34. A method as claimed in claim 38, wherein the angle of deviation is constrained to a predetermined range.

35. A method as claimed in claim 41, wherein the range of the angle of deviation is determined as a function of a range of angles within which the first line approaches the new point from the first point, and a predetermine angle of deviation.

36. A method as claimed in claim 32, wherein said method is performed to create the content of the virtual environment.

37. A method as claimed in claim 32, wherein said method is performed after the content creation of the virtual environment to dynamically determine the path.

38. A method as claimed in claim 32, wherein said path determined has a dynamically changing destination node.

39. A method of generating an automated path along some of a plurality of points in a virtual environment in which the rate of curvature of the path as a function of distance along the path is constrained, the method comprising determining the path in a topology comprising a plurality of initially defined points, and obstructions through which the path cannot pass, and in which two points are said to have line of sight in said topology if a straight line link between the two points does not pass through any of the obstructions, the method comprising:
(a) selecting a start point and an end point for said path in said virtual environment;
(b) dynamically redefining the topology of the virtual environment in the vicinity of said start point and said end point and the region between said start point and said end point by generating a plurality of additional points, wherein said plurality of additional points are generated by repeating the following step:
defining a new point located between a first existing point and a second existing point, wherein a first line between the first point and the new point and a second line between the new point and the second point do not pass through any of the obstructions; and
(c) calculating the path based on any combination of new and/or initially defined points, wherein the angle of deviation of the first line to a line between the first and second points is constrained.

40. A method as claimed in claim 39, wherein the speed of navigation along the path is determined as a function of the rate at which the degree of curvature of the path changes as a function of distance along the path.

41. A system for determining a path along some of a plurality of points in a representation of an environment, the representation comprising a plurality of initially defined points, and obstructions through which the path cannot pass, the system comprising:
processing means to define a plurality of additional points by repeatedly defining a new point located between a first existing point and a second existing point, wherein a first line between the first point and the new point and a second line between the new point and the second point do not pass through any of the obstructions; and
processing means to calculate the path based on any combination of new and/or initially defined points, wherein the angle of deviation of the first line to a line between the first and second points is constrained to ensure that the rate at which the curvature of the path varies as a function of position along the path falls within a predetermined range of values.

42. A system as claimed in claim 41, wherein the system further comprises means to enable a user to be automatically navigated along said path.

43. A system as claimed in claim 41, wherein the system further comprises means to enable a user to select rate at which the curvature of the path varies as a function of position along the path.

44. A user interface for a navigational system as claimed in claim 41, wherein the user interface is arranged to provide said means to enable the user to select the rate at which the curvature of the path varies as a function of position along the path.

45. A storage medium carrying computer readable code representing instructions for causing one or more processors to perform the method according to claim 1 when the instructions are executed by the processor or processors.

46. A computer program comprising instructions for causing one or more processors to perform the method according to claim 1 when the instructions are executed by the processor or processors.

47. A computer data signal embodied in a carrier wave and representing instructions for causing one or more processors to perform the method according to claim 1 when the instructions are executed by the processor or processors.

48. A storage medium carrying computer readable code representing instructions for causing one or more processors to operate as the system according to claim 18 to when the instructions are executed by the processor or processors.

49. A computer program comprising instructions for causing one or more processors to operate as the system according to claim 18 when the instructions are executed by the processor or processors.

50. A computer data signal embodied in a carrier wave and representing instructions for causing one or more processors to operate as the system according to claim 18 when the instructions are executed by the processor or processors.
